(19) United States
(12) Patent Application Publication
(10) Pub. No.: US 2010/0114604 A1
(43) Pub. Date: May 6, 2010

(54) Authorization Process for High Intensity Medical Interventions

(76) Inventor: Joseph Bernstein, Haverford, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/262,863

(22) Filed: Oct. 31, 2008

(51) Int. Cl. G06Q 50/00

(52) U.S. Cl. 705/3

(57) ABSTRACT

An authorization process for high intensity medical interventions (e.g., diagnostic, therapeutic) which includes the steps of: entering information regarding a patient and a particular service request into a computer-based algorithm; generating questions based on the information; receiving responses to the generated questions; assessing the responses to the generated questions; and determining whether a high intensity medical intervention is indicated.

### BACKGROUND OF THE INVENTION

The cost of health care in the United States has risen faster than the expansion of the economy overall for many years. This growth has significantly increased the pressure on third party payers, like HMO and Medicare, to limit the care provided by physicians to only that which is necessary.

It goes without saying that waste comprises even the smallest instances of needless consumption. Yet the attention of those attempting to limit waste is appropriately focused on the wasteful use of expensive and expansive modes of medical interventions, the diagnostics and therapeutics which have been designated “High Intensity Medicine.” High intensity medicine comprises diagnostics tests (e.g., magnetic resonance imaging or MRI), high cost pharmaceuticals (e.g., COX-2 inhibitors), and many types of medical procedures. Also within the rubric of high intensity medicine would be referrals of patients to physicians who specialize in a particular medical field, as those latter physicians more likely invoke expensive diagnostics and therapeutics procedures for their patients. In sum, high intensity medicine includes any mode of diagnostic or therapeutic medical care, often selected by a primary care physician, for which less expensive alternatives exist.

High intensity medicine often provides very valuable results for patients. For example, magnetic resonance imaging (MRI) is able to detect subtle abnormalities better than a typical x-ray. Nonetheless, high intensity medicine is very expensive and, in many instances, it can be argued that the marginal gain of such medicine to a patient is outweighed by the marginal costs of the medicine. Thus, a significant debate exists as to whether the value added by the use of high intensity medicine (e.g., MRIs, COX-2 inhibitors, specialty procedures) justifies their relatively higher cost compared to more traditional, less expensive alternative types of medication (e.g., x-rays, generic anti-inflammatories, primary care, respectively) that they may supplant. As such, programs to limit the use of high intensity medicine often appeal to third party payers; namely, those expected to underwrite the costs of such interventions.

In situations where the marginal gain from the use of high intensity medicine does not justify the additional cost associated with the medicine, waste may be prevented and savings may accrue if the use of high intensity medicine is restricted. It is on this premise that third party payers have instituted authorization procedures (so called pre-certification or screening programs) for interventions of this type. These programs or procedures attempt to determine whether the high intensity medicine sought is medically reasonable and necessary—or, in medical parlance, “indicated”—and limit the allowable care to only such indicated uses.

### Current State of Methods for Authorizing High Intensity Medical Interventions

Given the precipitous increase in medical spending in the United States, third-party payers have instituted various programs, processes and procedures for evaluating whether to authorize medical services in an effort to constrain the spending growth. In actuality, these programs, processes and procedures do not authorize or deny medical services but provide ex-ante assurance to, e.g., the physician and patient requesting a high intensity medical intervention that payment for the intervention will be made by the third-party payer. Thus, in practical terms, a third-party payer's authorization or denial of payment for a high intensity medical intervention is a de facto grant or denial of the service itself and, as a result, authorization for payment is tantamount to authorization of service.

The programs, processes and procedures implemented by third-party payers can be divided into three general categories: (1) gate-keeping; (2) rule-based review; and (3) case-by-case expert review. Gate-keeping is often mandated upon primary care physicians, and refers to a process whereby patients are not permitted to avail themselves of certain high cost medical services and, instead, must obtain prior approval (commonly referred to as a “referral”) from a primary physician to receive such services. Thus, gate-keeping employs a method of what might be called “rationing by hassle” as it constrains the consumption of expensive resources by making users (e.g., patients) pay for their consumption of particular medical services, not necessarily with money, but with time and energy. Only those users willing to make the effort to get a referral are able to avail themselves of the medical services otherwise blocked by gate-keeping. Additionally, it is hoped that those “keeping the gate” (e.g., primary care physicians) will employ at least a modicum of medical reasoning to ensure that high cost, medical services are used aptly.

Rule-based review also requires validation of a request for medical services, but here it is the third-party payer (or its agent) that approves or denies the request. Rule-based review programs determine whether to authorize a request for medical service on a case-by-case basis but under the direction of “rules” or criteria. For example, use of a high cost drug will likely only be granted if it has been documented that cheaper alternative drugs (e.g., a generic) have been tried without success. Another example of a rule-based review is a situation where a patient would not be permitted to have surgery to repair of a torn rotator cuff unless and until a physician obtains an MRI which confirms and documents the tear and the need for surgery.

Case-by-case expert review is similar to rule-based review in that a third-party payer (or its agent) approves or denies requests for services on a case-by-case basis. However, unlike rule-based review systems, case-by-case expert review depends upon and relies on input from a hired medical expert who reviews details of a patient's case including, possibly, contacting the patient's primary care providers in an effort to determine whether high cost, medical services are necessary.

The goal of all three of these authorization processes (gate-keeping, rule-based review and case-by-case expert review), including combinations thereof, is to limit high intensity medicine to situations is which it is indicated (i.e., medically reasonable and necessary) and to disallow it when it is not indicated.

### Limitations of Current Approaches to Authorization

There are several shortcomings, limitations and problems associated with known authorization processes. Gate-keeping is limited, foremost, by its unpopularity. After all, it is a rationing by hassle method and those who are hassled do not like it. Also, it tends to place primary care physicians in conflict with their patients, as what the third-party payer wants (and is willing to reward) is not necessarily what the physician deems to be in the patient's best interest. And, to the extent that third-party payers try to minimize this conflict by making the rewards for gate-keeping small, they likewise minimize the incentives for compliance with the gate-keeping process.

Rule-based systems are hampered by their crudity. There is sufficient variation in the presentation of disease and sufficient variation in the skill of physicians that it would be verging on impossible to construct rules that are at once adequately sensitive and specific. For example, an experienced physician could intuit a priori, that alternative drugs would be ineffective in treating a patient's condition and therefore know to immediately prescribe the more effective, albeit more expensive, drug. Similarly, a physical examination by an experienced physician might be more accurate than an MRI at detecting a rotator cuff tear that needs repair. Thus, like gate-keeping, rule-based systems tend to be unpopular with both physicians and patients, as they tend to impose “rules” without adequate consideration of, for example, the experience of a physician and the facts and circumstances of each particular case.

Case-by-case expert review overcomes some of the limitations noted above but at a considerable cost. Because an expert is hired directly by a third-party payer to examine a patient's case, and is not an agent of either the patient or the physician, there is no conflict of interest. Also, because the expert is able to examine the nuances of the assigned case, Procrustean application of guidelines or “rules” can be avoided. Nevertheless, case-by-case expert reviews are labor intensive and therefore very expensive. Additionally, denials of services may seem capricious even when the third-party payer engages in a discussion with the expert. The reason for this is that the very flexibility that allows for nuanced thinking by the expert can be interpreted by the physician (whose service request was denied) as whimsical and erratic.

### BRIEF SUMMARY OF THE INVENTION

The present invention overcomes the disadvantages of the prior art by providing an improved authorization process for high intensity medical interventions. It is an external method or process which enables it to avoid the conflicts inherent in primary care gate-keeping. It is also a transparent process in that its reliance on evidence-based medicine is apparent to anyone who examines its inner workings. The present invention comprises an algorithm which is cheaper to implement than case-by-case expert review and more accurate than typical rule-based systems. More specifically, the present invention relates to an authorization process for high intensity medical interventions which includes the steps of: entering information regarding a patient and a particular service request into a computer containing the algorithm; generating questions based on the information; receiving responses to the generated questions; assessing the responses to the generated questions; and determining whether a high intensity medical intervention is indicated.

In a preferred embodiment, the algorithm initiates a dialogue with a user (typically a physician) requesting a particular high intensity medical intervention in order to review the various indications for the intervention with the user. By doing so, the algorithm elicits from the user the same or similar clinical parameters that a medical expert would consider when determining indications for the requested high intensity medical intervention. These parameters enable the algorithm to develop an estimate of medical appropriateness and to refine the estimate of appropriateness as the dialogue proceeds. Additionally, instructional feedback can be provided to the user based on the user's responses during the dialogue. As a result, the users will be instructed about the appropriateness of their medical request.

Significantly, the algorithm does not explicitly authorize or deny any request for a medical service. Nevertheless, the algorithm of the present invention leads to decreased utilization of high intensity medical services because physicians will be disinclined to follow through with a particular medical service if the algorithm counsels against it. The positive incentive relies on physicians' professional ethics and standards which drive them toward optimal practice. Physicians want to the right thing, but might not know what that entails. The algorithm teaches the right course. As such, the algorithm leads to decreased utilization because it is able to instruct motivated users on optimal medical practices. It also leads to decreased utilization because physicians, once informed of the correct approach and moreover that their behavior is monitored, will not want to choose the wrong approach, independent of professional ethics.

By way of analogy, such self-restraint by physicians will result from dual incentives—carrots and sticks. Instruction and professional aspirational standards are the carrots. The stick is the threat of evaluation and the public identification of poor performance. The algorithm of the present invention is capable of retaining all responses and, as a result, those who request high intensity medical interventions without the appropriate aforethought will be so identified. Even worse, those who provide interventions not recommended by the process of the present invention are capable of be identified and possibly “branded” accordingly. Thus, while the wish to use medical resources aptly may be a normative professional standard for physicians, a desire to avoid being labeled as a poor practitioner is an even stronger universal trait among physicians.

The algorithm is entitled Socratic Superego. Socrates is, of course, famed not only as a father of philosophy in general but as an interlocutor in particular, a teacher whose dialogues lead participants to self discovered wisdom. For Socrates, it was less a matter of giving the right answers than helping others find these answers on their own. The Superego is a name bestowed by Freud on the mental process that discerns between right and wrong, motivates behavior to match ideals, and powers self-restraint. These two identities encapsulate what the authorization process of the present invention aims to foster; namely, the individual discovery of the correct indications for high intensity medicine and the self-imposed discipline to follow those correct indications.

It is therefore an object of the invention to, by teaching the user about the appropriate use of medical resources, reduce the occurrence of high intensity medical interventions lacking correct indications.

It is another object of the invention to, by monitoring medical decision making, produce performance metrics.

It is still another object of the invention to, by informing and reminding users of the monitor in place, promote self-restraint.

It is another object of the invention to, by relying on self-restraint and not external constraints, minimize professional resistance and hostility.

It is a yet another object of the invention to, by employing transparent standards supported by Evidence Based Medicine, garner the endorsement of the medical community.

It is a further object of the invention to, by implementing the algorithm with the techniques of Natural Language Processing/Artificial Intelligence, to create an interface whose complexity can be adjusted to yield the desired level of user difficulty.

### BRIEF DESCRIPTION OF THE DRAWINGS

The invention will be described, in part, in conjunction with the following drawings in which:

FIG. 1 is a schematic diagram of one embodiment of the present invention,

FIG. 2 is a schematic diagram of a second embodiment of the present invention;

FIG. 3 is a schematic diagram of a third embodiment of the present invention; and

FIG. 4 is a schematic diagram of a fourth embodiment of the present invention.

### DETAILED DESCRIPTION OF THE INVENTION

The present invention is directed to a method, system or process (henceforth referred to as “the program”) that screens requests for high intensity medical interventions, assesses their appropriateness and thereby reduces inappropriate utilization. In a preferred embodiment, the program engages a physician in a dialogue about a patient's health and, in so doing, provides a gate-keeping function for determining whether or not a particular medical test or intervention is appropriate (that is, “indicated”). If desired, the length and/or complexity of the dialogue can be regulated.

The present invention is not limited to any particular medical intervention and, instead, is directed to any type of intervention for which a studied decision regarding appropriateness can be made. Thus, the present invention includes interventions such as the referral of patients to specialists and non-physician professionals, elective surgical procedures and minimally invasive non-surgical procedures, as well as non-emergency basis procedures. The medical interventions contemplated by the present invention also include, but are not limited to, medical diagnostic and therapeutic interventions including high cost radiology services (such as magnetic resonance imaging (MRI); computerized tomography (CT); ultrasonography (U/S) and nuclear medicine scans), pharmaceuticals, non-medical treatments (e.g., physical therapy), specialty referral (such as surgical consultations); hospital admission; and medical procedures (cardiac angiography, to name only one).

In its broadest embodiment, the present invention is an authorization process for high intensity medical interventions which includes the steps of: entering information regarding a patient and a particular service request into a computer containing an algorithm; generating questions based on the information; receiving responses to the generated questions; assessing the responses to the generated questions; and determining whether a high intensity medical intervention is indicated. The present invention is also capable of generating additional questions tailored to the responses provided by a user (e.g., a physician or physician's designee) and, if desired, to provide instructional feedback to the user based on the responses.

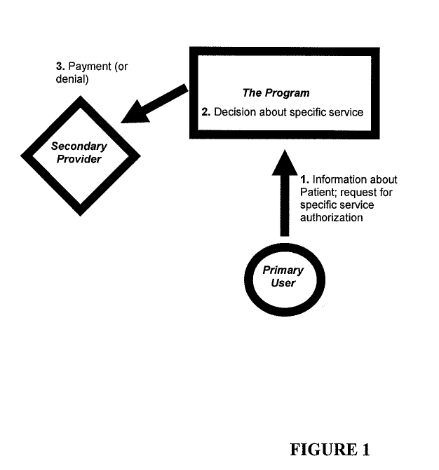

FIG. 1 shows a general scheme of operation of an embodiment of the present invention. A user, most typically a primary care physician, interacts with the program seeking “authorization” from a payer or provider for a desired medical intervention such as those enumerated above. This top level scheme is similar to known methods of medical pre-certification.

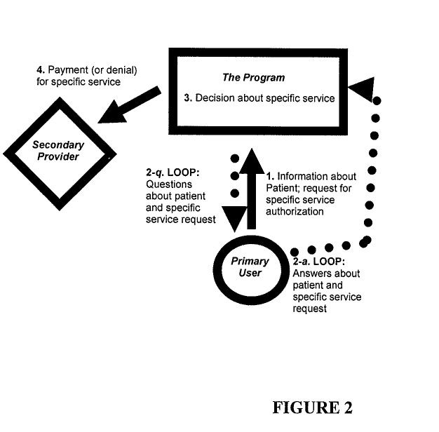

However, as shown in FIG. 2, the top level scheme of the present invention is improved at the point of interaction between the program and the user. This interaction is conceived as a conversation. This conversation is a computer-based (artificial intelligence application) dialogue similar to what takes place between a teacher and a student at medical schools around the world: questions are asked about a patient and answers are provided by the student. These answers can be used to refine a model representing the patient's true state, including his or her medical condition, and to define, further, the teacher's subsequent questions.

The universe of appropriate questions and their proper invocation regarding a specific intervention are generally known to those skilled in the art. In general, a diagnostic test is indicated if and only if its results will alter the patient's clinical course. Similarly, a therapeutic intervention is indicated if the utility of its likely outcomes are valued more than the utility of the likely outcomes of rival options—including the default option of doing nothing. In short, the establishment of indications is an exercise in decision analysis, a domain well-defined in the prior art. However, the program leads this exercise using establish logical techniques applied to medical facts, thresholds and criteria as documented in medical literature; that is to say, it leads a user through the steps of practicing Evidence Based Medicine.

For example, considering a case of requesting MRI of the lumbar spine, the user will be asked what diagnoses are considered; the “pre-test probability” of these diseases (that is, how likely a patient has a particular condition even before any test is performed); treatments considered; and the level of probability at which the treatments would be invoked, the so-called “treatment threshold.” Based on the sensitivity and specificity of a particular test or examination (e.g., the test's power to change the probability of disease, given its results using Bayesian logic), boundaries are set which establish the point at which a particular test or examination is indicated.

The program of the present invention not only asks questions and chooses further questions based on the responses it obtains, but it is also capable of providing commentary to users on their responses. For example, if a user requests an MRI without a prior x-ray because he or she thinks that the likelihood of degenerative disc disease in a 64-year-old obese smoker is only 10%, the program would share with the user that well-established data reveals a much higher prevalence. By way of another example, if a user requests an MRI of the lumbar spine to establish surgical indications, the program might ask: Have you asked the patient if surgery would be accepted even if the MRI were positive? Should the physician then respond that physical therapy could be chosen, the program might counter by asking: Why don't you do this empirically? In doing so, the process of the present invention aims to promote thinking by the user.

It follows that an embodiment of the present invention is directed to authorization of high-intensity medical interventions having the following features:
generating questions a qualified physician would need answered to determine whether a desired intervention is indicated;
employing methods of artificial intelligence to modulate a dialogue between the program and a user;
providing feedback to responses offered by the user in order to modulate the user's thought process;
retaining the user's responses to questions;
assessing the user's medical decision reasoning ability; and
determining whether indications for the intervention are present.

Importantly, the present invention generates questions that typically can be answered only by a knowledgeable practitioner (e.g., a physician), such that the authorization process cannot be easily delegated to a user who is not, for example, familiar with the patient, trained in the administration of medical examinations, or trained in the practice of medicine (e.g., an office worker). This does not necessarily preclude such a person (e.g., an office worker) from entering information into a computer, but the present invention aims to place some barriers to prevent the user from delegating the work (and thereby externalizing the costs) of compliance with the program of the present invention.

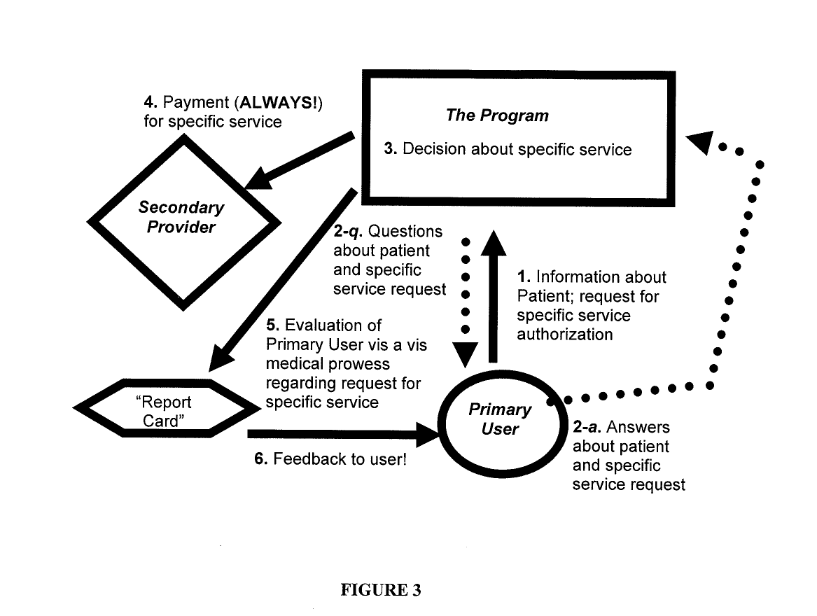

The scheme described thus far uniquely uses a request for medical service as an opportunity to instruct a user of the proper indications for that service. That is the Socratic aspect of the program. However, as shown in FIG. 3, a unique feature of the present invention is its use as a screening method (the Superego feature). The program provides a recommendation as to whether a high intensity medical intervention should be performed. Importantly, however, it never issues an explicit denial when the medical intervention is requested. Rather, all requests are approved. If desired, the quality of the medical reasoning that drives a user's request for a particular medical intervention and the user's subsequent actions related to the request can be recorded in electronic form and/or used to generate metrics of the user's skill. It is expected that, once the user is informed that his or her responses to the questions generated by the program are a basis for evaluating performance, the user will, in turn, desire to score highly on these metrics. The user will modulate his or her behavior and provide self-restraint regarding the utilization of high intensity medical resources.

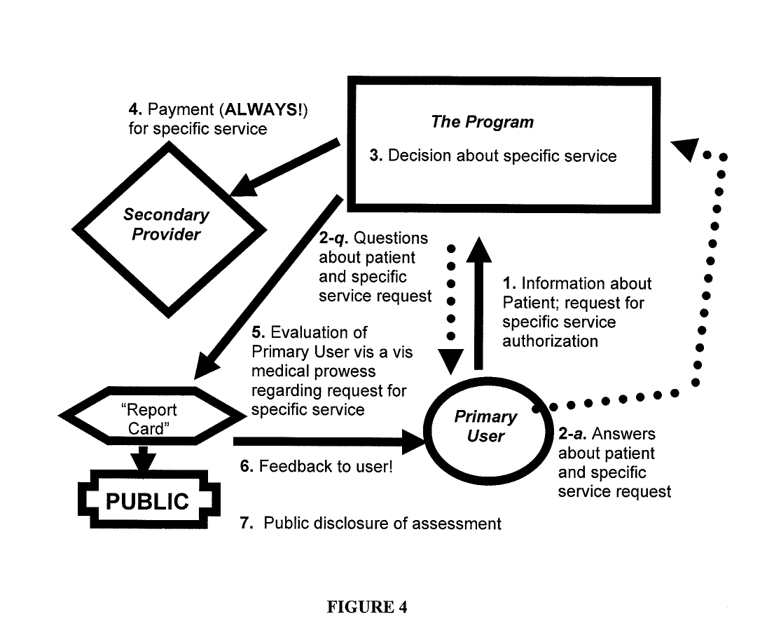

Referring now to FIG. 4, an added incentive for high quality performance, which manifests as a high degree of medical reasoning and a low rate of inappropriate usage of high intensity resources, is the ability of the present invention to provide public disclosure of the performance metrics (a “report card”). This amplifies the power of the present invention, not only in its reliance on public approbation, but in terms of how it might influence the relationship between the user and other third-party payers (e.g., not the one utilizing the program). By analogy, this feature of the invention is similar to how a car accident is reported to an automobile insurance company who, in turn, creates a semi-public record of the driver's performance. The effect of such reporting is that another insurance company (one with which the driver has no current relationship, but might deal with in the future) may use the driver's history to influence its automobile insurance pricing. In other words, third-party payers, without any collusion between them, may find it is in their best interest to share these report cards. At present, the costs of high intensity medical interventions are for the most part externalized, often excessively so. By forcing the user to consider the personal effects of his or her decision-making, these decisions are aptly re-internalized, at least to some degree.

As a first approximation, performance metrics can be built on the dialogue. For example, the program can determine whether the user asks the appropriate questions and knows the appropriate answers to those questions. The program could also determine the rate of utilization for marginally indicated services; that is, whether the user authorizes and executes a service despite the fact that it was not recommended by the program. Additional metrics can be obtained by auditing the performance of a user. This includes auditing office charts, comparing responses to the facts in the chart and examining the outcomes that result from the user's plan of action.

It is a particular advantage of the present invention to allow all requests as, by doing so, it does not in any way “practice medicine” or explicitly ration care. There are no denials to protest as all restraint emanates solely from the users as part of the process of giving duly diligent consideration of the ramifications of their decisions. As a result, the process of the present invention merely reminds a physician of his or her obligation to think and enforces that obligation only indirectly. If one employs a definition that all “well considered” interventions are indicated precisely because they were considered, by allowing an intervention only after it has been considered, the present invention inherently limits high intensity medicine to only that which is indicated. That is, the very process of determining whether the high-intensity intervention is indicated perforce makes the intervention indicated.

It follows that, because present invention does not actually deny any medical examination, it does not need a physician to approve the decision to deny the requested intervention—as is the case in many states—and does not raise issues of medical liability.

Although an embodiment of the present invention pre-certifies all interventions, it is also within the scope of the present invention to develop criteria for identifying particularly poorly indicated interventions, and flag them for denial (after human review).

In sum, unlike known authorization processes, an embodiment of the present invention engages a user (e.g., a physician) in a computer-based dialogue with a goal of making the user consider the indications of requested interventions; to instruct the user about these indications; and to grant all requests, relying not on the power of external denial but on that of internal self-restraint to limit inappropriate utilization of high-intensity services. Additionally, if desired, the process of the present invention can include the step of creating a “report card” on the physician's diagnostic reasoning and clinical acumen. This would also likely result in the physician self limiting the use of medical examinations.

What is claimed is:

1. An authorization process for high intensity medical interventions comprising the steps of:
entering information regarding a patient and a particular service request into a computer containing an algorithm;
generating questions based on the information;
receiving responses to the generated questions;
assessing the responses to the generated questions; and
determining whether a high intensity medical intervention is indicated.

2. The authorization process of claim 1, further comprising the step of generating additional questions tailored to the assessed responses.

3. The authorization process of claim 1, further comprising the step of providing instructional feedback to a user of the computer based on the received responses.

4. The authorization process of claim 3, wherein the user is a physician or a physician's designee.

5. The authorization process of claim 1, further comprising the step of retaining the received responses.

6. The authorization process of claim 5, wherein the retained responses are recorded in electronic form.

7. The authorization process of claim 5, wherein the retained responses are used to create at least one skill rating of a user of the computer.

8. The authorization process of claim 5, wherein the retained responses are used to audit performance of a user of the computer.

9. The authorization process of claim 1, wherein the algorithm comprises artificial intelligence and natural language processing.

10. The authorization process of claim 9, wherein an output of the algorithm is a dialogue with a user of the computer.

11. The authorization process of claim 10, wherein at least one of a length and complexity of the dialogue is regulated.

12. The authorization process of claim 1, wherein the determining step is based on Evidence Based Medicine.

13. The authorization process of claim 1, further comprising the step of instructing a user of the computer on indications of the intervention.

14. The authorization process of claim 13, further comprising the step of informing the user that the received responses are a basis of evaluating the user's performance.

15. The authorization process of claim 14, wherein the determining step comprises always issuing an approval of the intervention.

16. The authorization process of claim 1, wherein the intervention is a diagnostic test.

17. The authorization process of claim 16, wherein the diagnostic test is a radiology test.

18. The authorization process of claim 1, wherein the intervention comprises the use of at least one therapeutic.

19. The authorization process of claim 18, wherein the therapeutic is a pharmaceutical drug.

20. The authorization process of claim 1, wherein the intervention is selected from the group consisting of: referral of patients to specialists; referral of patients to non-physician professionals; elective surgical procedures; elective minimally invasive non-surgical procedures; and non-emergency basis procedures.
